(19) United States
(12) Patent Application Publication
(10) Pub. No.: US 2005/0016915 A1
(43) Pub. Date: Jan. 27, 2005

(54) Permeable membrane

(76) Inventor: David A. Beck, Appleton, WI (US)

Correspondence Address: Todd Tl Taylor;Taylor & Aust, P.C., 142 S. Main Street, P.O. Box 560, Avilla, IN, 46710, US

(21) Appl. No.: 10/864,034

(22) Filed: Jun. 9, 2004

Related U.S. Application Data
(63) Continuation of application No. PCT/EP02/14656, filed on Dec. 20, 2002.

(30) Foreign Application Priority Data
Dec. 20, 2001 (GB) 0130431.0

(51) Int. Cl. D21F 5/14; B01D 71/06

(52) U.S. Cl. 210/490; 162/358.1; 34/122; 162/290; 210/500.27; 210/503

(57) ABSTRACT

A permeable membrane, for use in a displacement press or for converting an air press into a displacement press. The permeable membrane including a laminate structure having a plurality of layers including at least one permeable wear layer and at least one semi-permeable perforated sheet layer.

### CROSS REFERENCE TO RELATED APPLICATIONS

This is a continuation of PCT application No. PCT/EP02/14656, entitled “PERMEABLE MEMBRANE”, filed Dec. 20, 2002.

### BACKGROUND OF THE INVENTION

1. Field of the Invention

The present invention relates to a permeable membrane, and, more particularly, to a permeable membrane for use on a displacement press arrangement having a plurality of rollers forming a chamber, and that may be used to convert an air press to a displacement press.

2. Description of the Related Art

In a conventional press-section of a papermaking machine, water is squeezed out of the formed paper web between one or more pairs of nips. More recently, extended nip presses have been developed, which give increased dewatering due to the increased nip length. It has also been shown that more water could be removed, and higher sheet bulk maintained, if air pressure could be applied to supplement roller nip generated pressures. U.S. Pat. Nos. 4,888,096 and 4,675,079 discuss such methods of displacement dewatering also known as displacement pressing. The term displacement dewatering was used in a paper presented by J. D. Lindsay at the Helsinki Symposium on Alternate Methods of Pulp and Paper Drying, on Apr. 7, 1991. He described displacement dewatering as a process whereby, “a pressurized air or steam phase is used to expel liquid water from paper while the paper is simultaneously under mechanical pressure”.

U.S. Pat. No. 6,190,506 (Beck) discloses a method of carrying out displacement pressing on a continuous basis. This process uses a multi-roller structure to form a closed chamber into which air is introduced. This process, as compared to conventional wet pressing, has been shown to result in higher bulk and solids, which leads to savings in fiber and energy. In order for this process to work to its full capacity, it requires a top fabric, or pressure membrane, which will convert the air pressure into mechanical pressure, whilst at the same time controlling the flow of air through the web. Such a fabric requires a low, yet precise, uniform and stable permeability that is approximately 100 times less permeable than a conventional wet felt. Conventional methods of controlling permeability, such as coating or needling have not been effective to create a membrane with stable, low and uniform permeability.

U.S. Pat. No. 6,274,042 (Beck) and European Patent EP 1,088,934 each describe a membrane suitable for use in a pressing apparatus as described in U.S. Pat. No. 6,190,506. Each membrane is formed as a unitary member having longitudinal edge portions, which are impermeable and the inner portion, therebetween, having a plurality of holes therethrough rendering the inner portion semi-permeable. In one embodiment of U.S. Pat. No. 6,274,042, the membrane is in the form of a unitary, coated fabric, the coating forming a flow resistant layer near the surface of the membrane, which in use is closest to the chamber. European Patent EP 1,088,933 (Voith Paper Patent GmbH) describes a membrane for use in a pressing apparatus. This membrane is in the form of a homogenous woven fabric having a semi-permeable portion including a plurality of pores provided between two longitudinal edge portions. U.S. Pat. No. 6,416,631 (Beck) describes a semi-permeable membrane with a permeability of less than about 5 cfm and having a semi-permeable central portion and impermeable edge strips. The membrane is positioned on the upper side of the paper web, to separate the web from direct communication with the chamber. The membrane is formed from a unitary, rubberised fabric, which is made permeable by forming holes therethrough. This patent also describes the possible provision of a hydrophobic layer positioned on the underside of the web adjacent to the supporting felt layer, its purpose being to inhibit rewet.

The pressing membranes disclosed in the above described prior art are all of a unitary composition with holes formed therethrough, for example, usually by way of a laser. It has been found that the columns of pressurised air pass down the plurality of holes, leading to localized dewatering. Areas of the web beneath the membrane where there are no holes are dewatered less efficiently.

In an air press for dewatering wet webs, for example, the arrangements described in the International Publications WO00/23301 (Kimberly-Clark), WO 99/23296 (Beloit), or U.S. Pat. No. 6,454,905 (Kimberly-Clark), air passes through a paper web supported between two forming fabrics. Dewatering is aided by the provision of a vacuum box and a pressurized plenum on opposite sides of the enclosed web. However, forming fabrics are very open, this means that the pressurized air in the plenum is unable to squeeze the sheet/web to the same extent as an air displacement press. The consequence of this lack of sheet compression is that there is less free water readily available to be driven out by the air, which leads to less efficient dewatering.

Accordingly, a need exists for an improved membrane, which provides even dewatering of a continuous web on a micro-scale, and provides efficient control of airflow within the chamber.

### SUMMARY OF THE INVENTION

It is an object of the present invention to provide a uniformly permeable membrane for effecting enhanced dewatering of a continuous web, such as paper, and provide efficient control of airflow within the chamber of a displacement press.

It is a further object of the present invention to convert an air press into a displacement press, by using a uniform low permeable membrane, thereby increasing dewatering of a continuous web, such as paper, whilst also providing efficient control of airflow through the web and more even dewatering.

In accordance with one aspect of the present invention, there is provided a permeable membrane, for use in a displacement press or for converting an air press to a displacement press, the membrane including a laminate structure having at least one permeable wear layer and at least one semipermeable perforated, sheet layer.

The provision of the semipermeable, sheet layer provides enhanced dewatering, the permeability of the semipermeable layer can be selected to provide a controlled airflow for a particular application. The permeable wear layer helps to further diffuse the air, thereby facilitating a uniform flow of air therethrough leading to a more even dewatering. Furthermore, the permeable wear layer protects the sheet layer, ensuring stable permeability over the life of the membrane. The aforementioned displacement press process requires a thin fabric to reduce compressed air consumption and to create low-leak seals, when passing through the rolling nips. Provision of the semipermeable, sheet-like layer enables the membrane to be thin, whilst the wear layer enables the membrane to be strong and stable enough to run on such presses.

The layers may include at least one woven layer. This has the further advantage of providing high tensile strength and low stretch. Whilst woven fabrics are strong in the machine and cross machine directions, when, for example, running on a paper machine, they are weak along the 45° bias direction. Forces applied in the 45° bias direction can cause the fabric weave to distort since there are no yarns running in this direction. The provision of the semipermeable sheet layer has the advantage that the 45° bias strength is greatly increased, since the bonded sheet layer resists fabric distortion. The layers may include at least one non-woven layer, the non-woven textile may be made of a non-woven substance, such as a spun-bonded or a hydro-entangled product.

The permeable wear layer may be selected such that it carries the load and prevents the semipermeable sheet layer from reaching its yield point. By preventing sheet yield, the laminate structure is more stable, further enhancing the life of the membrane.

Preferably, the membrane properties on either side of the membrane's natural plane are symmetrical. The semipermeable sheet may be a polymeric sheet. By balancing tensile and thermal-tensile properties, in the case of a polymeric sheet, on each side of the membrane's center, membrane curl can be eliminated and internal stresses reduced, resulting in longer membrane life.

In another embodiment, all of the sheet layers are polymeric and include a plurality of pores. The distribution and size of the pores in each individual sheet layer can thereby be readily selected to provide a membrane of a desired permeability. A uniform pore size and distribution provides enhanced dewatering.

In yet another embodiment there are two such wear layers and these form the outer layers with the at least one semipermeable sheet layer interposed therebetween. This has the advantage that the outer wear layers protect the inner semipermeable sheet layers.

Preferably, at least two of the sheet layers are provided and a load carrying permeable layer is laminated between adjacent sheet layers. An inner load carrying permeable layer acts as an air-spreading layer and further enhances control of the membrane's permeability. Also, multilayer structures offer the advantage that the fabrics are easier to splice so as to make the membrane endless or wider. This is due to the fact that when there is more than one layer, the effect of splicing individual layers has a lesser effect on the total membrane performance. The potential marking and loss of strength of each splice being averaged out by the other layers above and below. Thus, it is possible to butt splice each layer in a stair-step fashion, ending up with a membrane that has little permeability variation in the spliced areas.

Pores are provided in at least two sheet layers. By selective positioning of the relative alignment of the pores in the different layers the overall permeability of the membrane can be adjusted to suit the needs of a product to be dewatered in a displacement/air press. In one embodiment the pores are smaller and/or fewer in the sheet layer nearest to the intended high-pressure side of the membrane, when compared to those of the sheet layer or layers nearest the intended sheet side of the membrane. For lowest energy consumption, when the membrane is used on a displacement/air press, most of its pressure drop is at the high pressure side of the membrane, therefore provision for the pores to be smaller or to be less frequent, or a combination of both, on the high pressure side provides a membrane, which is better adapted for use in such a process.

The layers can include materials from the list of polyesters, polyamides, polyurethane (PU), polyphenylene sulphide (PPS), polyetherether ketone (PEEK), polypropylene, polyethylene and temperature resistant materials. Preferably the outer layers are abrasion resistant, and/or resistant to soil pick-up and/or able to control static generation, which finds particular application in a dry environment.

The membrane may include through-channels arranged in a preselected manner. Such channels are used to create a watermark.

In one embodiment a wear layer is located at the web-facing side of the membrane. This has the advantage in that it acts to disperse or spread out the air after it leaves the semipermeable sheet layer. This enhances uniform dewatering. The spreading ability of this wear layer may be larger than the spacing between the holes in the sheet, which further enhances even air distribution across the web. In particular the land areas of the sheet acts to block the flow of air, thereby increasing flow resistance, whilst the combination of the wear-layer and holes in the sheet spread the air, thereby creating a uniform permeability. The uniformity may be further increased by providing a uniform distribution of holes and/or a uniformly permeable wear layer.

In another embodiment the permability of the membrane is less than 50 cfm, preferably less than 10 cfm and more preferably less than 5 cfm, when measured by TAPPI test method TIP 0404-20. The membrane includes at least three or at least five layers including a low permeable, high resistant layer on the intended high pressure side of the membrane. This side never sees water or paper. Providing a high flow resistant layer on the high pressure side helps to inhibit leakage under the pressure rollers.

The outer edges of the membrane may carry an impermeable coating. This enhances sealing around the paper web or sheet. The outer edges of the membrane may be tapered, this enhances the nip seal around the fabric of a press felt or the like.

In one embodiment of the present invention the membrane is a composite structure including a plurality of strips of the laminate structure, which have been spliced together to make a wider and/or longer and/or endless membrane.

Preferably, at least one of the strips have a stair-step pattern due to the offset arrangement of the edges of the individual layers within that strip, which strip is spliced to an adjacent strip having a substantially inverted image of that stair-step pattern. This arrangement has the advantage that splices in individual layers are effectively offset and thereby the permeability of the membrane is not significantly affected in the region of the splice.

Preferably, at least one of the layers of the membrane may be a composite structure including a plurality of strips of that layer which have been spliced together to make a wider and/or longer and/or endless structure. More preferably, there are at least two of the composite layers, each including a plurality of strips of that respective layer, which have been spliced together to make a wider and/or longer and/or endless structure, and with these composite layers laminated together such that said splices are substantially offset. This arrangement provides a membrane in which the splices in individual layers are not substantially aligned, and thereby the permeability of the membrane is not significantly affected by the presence of the splice. The strips may have a plurality of widths and/or lengths.

In accordance with a second aspect of the present invention there is provided a method of making a permeable membrane for use in a displacement press or for converting an air press to a displacement press, including the steps of providing a permeable wear layer and a semipermeable sheet layer, coating at least one side of the sheet layer with adhesive, perforating the adhesive coated sheet layer to provide pores through the film and adhesive, and laminating the perforated coated sheet layer to the permeable wear layer.

By perforating both the adhesive and the sheet at the same time, a bonding film is provided, which can be laminated to the wear layer, yet still maintain permeability. A superior membrane is obtained by this method, since applying adhesive after the perforation step can lead to blocking of the pores.

Preferably the step of coating includes coating both sides of the sheet layer with adhesive and the step of laminating includes laminating the coated sheet layer between two permeable wear layers. The wear layers forming outer layers of the membrane.

More preferably, the step of laminating further includes laminating two such perforated, adhesive coated sheet layers between the outer wear layers with a load carrying permeable wear layer between the sheet layers. This additional load carrying, permeable wear layer acts to spread the air. This air diffusion capability of a central layer, between the perforated layers, enhances control of the overall membrane permeability. By selective combination of the air spreading and the alignment of the perforations, the permeability of the membrane can be selectively controlled.

Perforation of the sheet layer can be accomplished by mechanical, or in the case of a polymeric sheet by thermal methods. It has been found that, where polymeric sheets are concerned, mechanical perforations can result in perforated films having a radial tear propensity. The thermal perforations provide a reinforcing ring of polymer around the holes, which improve tear resistance.

In accordance with a third aspect of the present invention there is provided a permeable membrane including a laminate structure having at least one permeable wear layer and at least one semipermeable perforated sheet layer when used as one of two endless fabrics on a displacement press as described herein, wherein the membrane is wider than the other endless fabric such that it covers the other fabric and any web carried thereon during web dewatering. An apparatus of this type, for dewatering a web, is described in U.S. Pat. No. 6,190,506.

The other fabric may also take the form of a permeable membrane. This has an advantage in that by also providing the support fabric for the web as a permeable membrane the carrier layer forms an anti-rewet layer.

Preferably, when the permeable membrane contains at least two sheet layers and is used as a support layer to prevent rewet, one of the layers is of a lower permeability than the other sheet layers and is located at the web supporting side of the membrane. This has the advantage that once the water has been forced through the web and the anti-wet support layer under pressure, there is less chance of the water being able to flow back and thereby reach the web due to lower permeability of the uppermost sheet layer.

In accordance with a fourth aspect of the present invention there is provided an air press, which has been converted into a displacement press using the permeable membrane or by using a low permeability membrane having a permeability of less than 50 cfm, as measured by TAPPI test method TIP 0404-20.

The air press may include an endless forming fabric and an endless support fabric which carry, in use, a web to be dewatered therebetween, through a pressurized plenum. The pressurized plenum is located above the forming fabric and a vacuum box is located below the support fabric, wherein the membrane is located between the plenum and the forming fabric. The membrane may be wider than the forming fabric or wider than the plenum thereby covering the exit of the plenum and enabling all air exiting the plenum to directly apply pressure to the membrane.

The support fabric may be in the form of a further permeable or further low-permeable membrane, or such membrane may be included in addition to the support fabric.

Air presses suitable for conversion to a displacement press using said permeable membrane are described in International Publication Nos. WO 99/23301 and WO 99/23296 and U.S. Pat. No. 6,454,905.

### BRIEF DESCRIPTION OF THE DRAWINGS

By way of example only, specific embodiments of the present invention will now be described with reference to the accompanying drawings, in which:

FIG. 1 is a cross-sectional view of a permeable membrane constructed in accordance with one of the embodiments of the present invention;

FIG. 2 is a partial perspective view of the membrane of FIG. 1 with the top permeable layer peeled back to better illustrate the perforated middle layer;

FIG. 3 is a partial schematic view of the use of the membrane of FIG. 1 on a roller configuration of a displacement press;

FIG. 4 is a view similar to FIG. 1 of a permeable membrane of another embodiment of the present invention;

FIG. 5 is a view similar to FIG. 1 of a permeable membrane of another embodiment of the present invention;

FIG. 6 is a view similar to FIG. 1 of a permeable membrane of another embodiment of the present invention;

FIG. 7 is a view similar to FIG. 1 of a permeable membrane of another embodiment of the present invention;

FIG. 8 is a view similar to FIG. 1 of a permeable membrane of another embodiment of the present invention;

FIG. 9 is a view similar to FIG. 1 of a permeable membrane of another embodiment of the present invention;

FIG. 10a to 10c are each schematic views showing the steps of a method of one embodiment of the present invention illustrating the splicing together of a plurality of strips of a membrane to make a wider membrane; and

FIG. 11 is a schematic view of an air press which has been converted to a displacement press using a membrane constructed in accordance with the invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

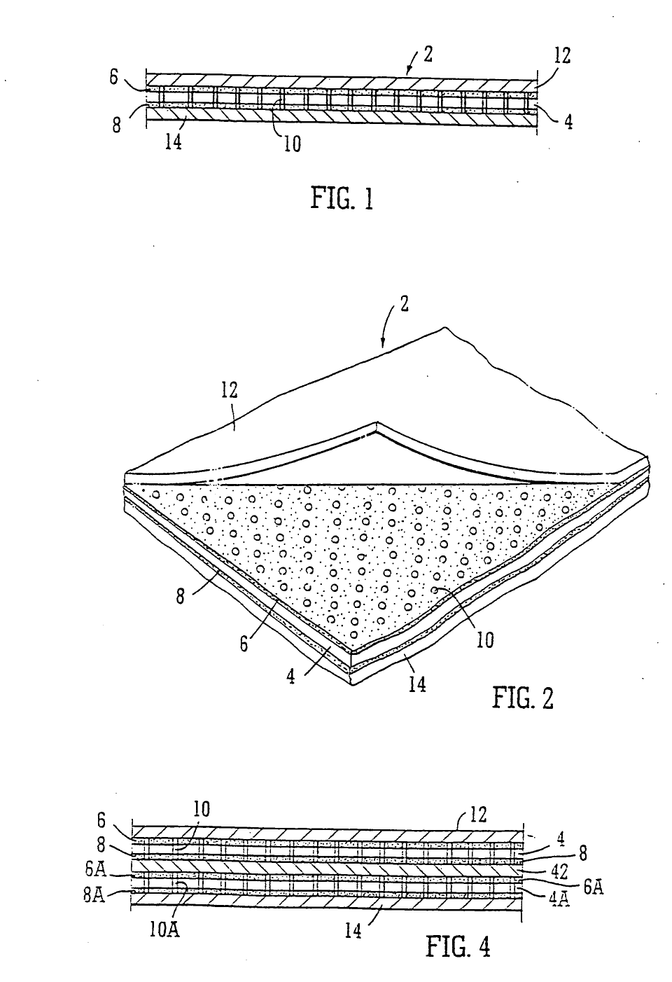

Referring now to the drawings, and more particularly to FIGS. 1 and 2, there is shown a first embodiment of the invention, membrane 2 made of a Mylar™ film layer 4 that is initially coated with adhesive on both sides to provide adhesive layers 6 and 8. Film 4 and adhesive layers 6 and 8 are then perforated, such that holes 10 are made through film 4 and adhesive layers 6 and 8. Outer fabric load bearing wear layers 12 and 14, in the form of a permeable top layer 12 and a permeable bottom layer 14 are then bonded by way of adhesive layers 6 and 8 to film 4. Outer wear layers 12 and 14 protect perforated layer 4 in the middle of membrane 2, ensuring stable permeability over the life of the membrane. The channels formed by perforation 10 extend between top layer 12 and bottom layer 14.

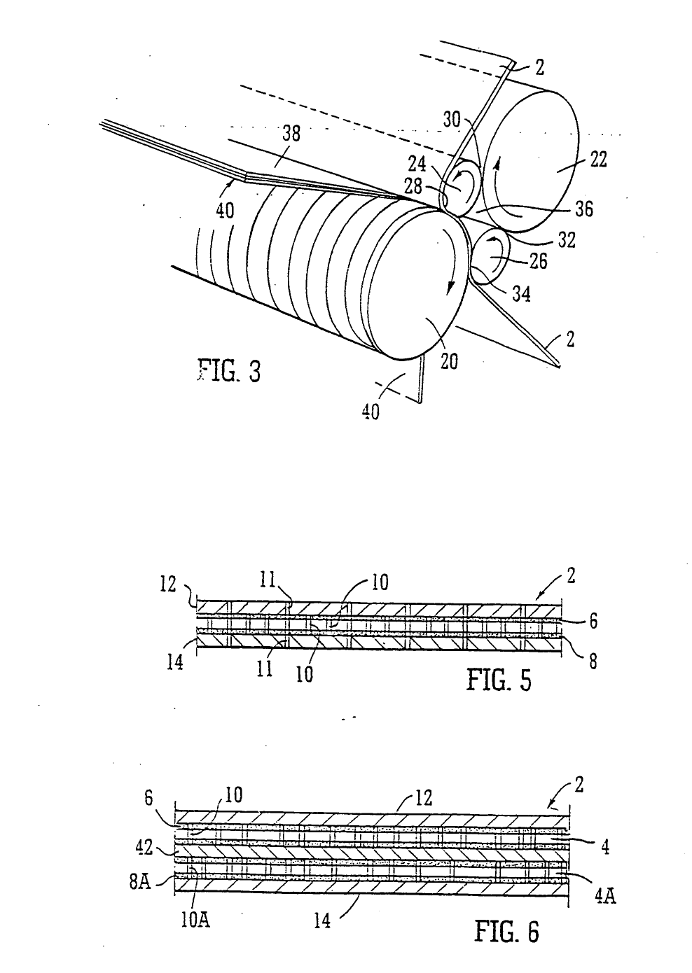

Now, additionally referring to FIG. 3, there is illustrated the roller configuration of a displacement press for which the present membrane 2 is particularly suited. The roller configuration includes two main rollers 20 and 22 and two cap rollers 24 and 26, which are used to create a seal along the axial extent of main rollers 20 and 22 at press nips 28, 30, 32 and 34. Chamber 36, in the form of a pressure cavity, is defined between four rollers 20, 22, 24 and 26. In this instance, membrane 2 is provided in an endless form and is routed over a portion of the circumferential surface of roller 20 by way of press-nips 28 and 34. Roller 20 takes the form of a vented roller and fluidly communicates with pressure chamber 36 by way of membrane 2. The vents in the roller extend around the roll and thereby communicate with the atmosphere. Rollers 22, 24 and 26 are in the form of solid rollers, which may include resilient coatings to aid in the sealing of pressure chamber 36, and are not in fluid communication with pressure chamber 36. A fluid source, for example, compressed air (not illustrated) is coupled with pressure chamber 36, and it flows into chamber 36 and out through roller 20 by way of the permeable membrane and any continuous web 38 or paper web carried through the nips by the press forming or anti-rewet fabric 40. This is due to a pressure difference between chamber 36 and the vents in the roller, which causes the air to flow from chamber 36 through membrane 2, web 38 and fabric 40 to the vents. The membrane helps diffuse the air to provide a uniform flow of air to web 38.

Membrane 2 has a greater width than that of continuous web 38 and press fabric 40. Because of this greater width and the fact that membrane 2, in use is the uppermost layer, that membrane 2 covers web 38 and press fabric 40, and makes direct contact at its edges with the surface of roller 20. By making this contact, air is not able to creep under the membrane and find its way into the vented areas of the roll. Thus, the underside of the membrane forms a seal with roller 20. Membrane 2 therefore controls the flow of air through the underlying web, presses the underlying web, and at the same time prevents short circuiting of air under the edge of membrane 2. In a further embodiment of the present invention press fabric 40 is in the form of a permeable membrane. This has the advantage of providing the dual advantage of providing both a support layer for the web, and also an anti-rewet layer. It is to be understood that such a permeable membrane may also be provided as an additional layer to the support layer.

Now, additionally referring to FIG. 4, there is shown a five layer design of membrane 2, in this instance two film layers 4 and 4A are provided, each coated with respective adhesive layers 6 and 8; 6A and 8A and each of the film and adhesive layers 4, 6 and 8 and 4A, 6A and 8A are then perforated, as described above, to provide channels 10 and 10A through each of the respective film and adhesive layers 4, 6, 8, 4A, 6A and 8A. A load carrying, permeable layer 42 is bonded via adhesive layers 8 and 6A between the perforated film and adhesive layers 4, 6, 8 and 4A, 6A, 8A and the membrane is completed by bonding outer wear layers 12 and 14 by way of adhesive layers 6 and 8A. Channels 10 in film and adhesive layers 4, 6, 8 are aligned with corresponding channels 10A in the film and adhesive layers 4A, 6A and 8A.

The inner three layers 4, 6 and 8; load carrying permeable layer 42; and layers 4A, 6A and 8A, control the permeability of the fabric. Outer wear layers 12 and 14 have a much higher permeability compared to the inner layers and help to diffuse air through channels 10 and 10A and protect the inner three layers from wear and other environmental effects. The provision of an inner wear, load bearing layer, increases the flexibility of the membrane. Although five layers have been illustrated, additional layers could be provided. Also, although the outer wear layers have been described as having a higher permeability than the inner layers, at least one of the outer wear layers, for example, top layer 12 may have a higher flow resistance, especially if the environment effects are not severe. The air spreading capability of permeable layer 42 is useful to allow control of the membrane permeability. The combination of spreading within the wear layer and channel alignment between multiple semi-permeable films, can be used to control the permeability of the structure.

Now, additionally referring to FIG. 5, there is illustrated another embodiment of the present invention, which is similar to the membrane of FIG. 1, additionally having perforations formed through completed membrane 2 to provide channels 11 through the entire membrane. It is to be understood that this design is extendable in a five or more layer membrane. By providing channels 11 straight through the membrane, it is possible to intensify dewatering in selected areas of a paper sheet/web. This for example could produce a watermark in the sheet as a result of deliberate perforations in the form of a pattern, on the membrane, such as a logo and/or a word made up of individual dots. The perforations in the film layers provide an enhanced and even dewatering effect in the rest of the membrane due to the high pressure air impacting on the membrane, which exerts a squeezing action on the sheet. The differential airflow, coming from straight-through channels 11 in the membrane, results in different levels of local dryness in the sheet, which will create a watermark.

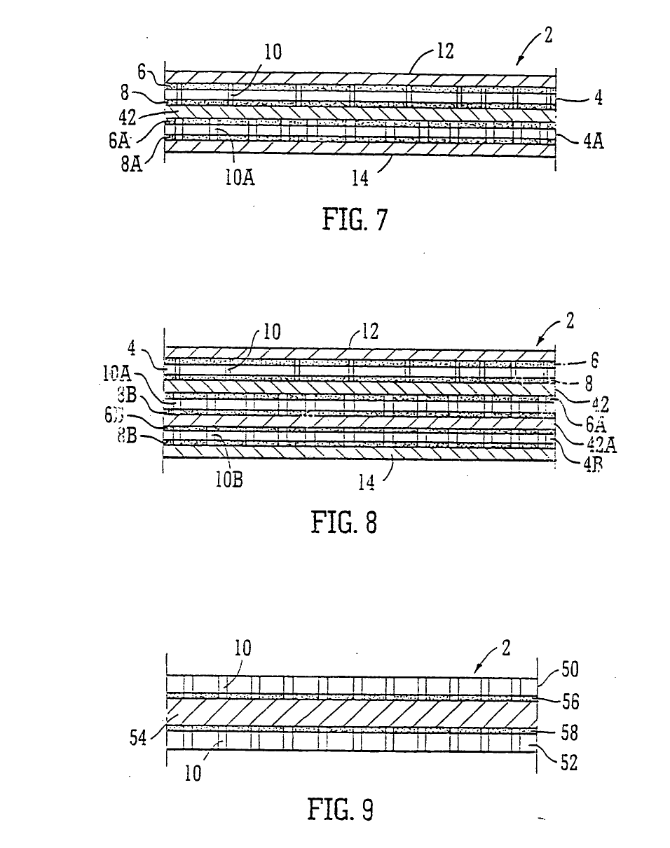

In the embodiment illustrated in FIG. 6, channels 10 through film and adhesive layers 4, 6 and 8 are not substantially aligned with channels 10A through film and adhesive layers 4A, 6A and 8A. Furthermore, a different distribution of channels is provided in each layer. The non-alignment of the channels between the layers makes the air take a tortuous path as it flows through the membrane, thereby dropping the air permeability to a much lower level than when the channels are aligned. In the embodiment illustrated in FIG. 7, film and adhesive layers 4, 6 and 8 have a fewer number of channels 10 than there are channels 10A in film and adhesive layers 4A, 6A and 8A. The perforations forming channels 10 are also of a smaller diameter than those of channels 10A.

In the embodiment shown in FIG. 8, a seven layer design is illustrated in which the embodiment of FIG. 4 is modified to include an additional load carrying permeable layer 42A and an additional film and adhesive layers 4B, 6B and 8B combination in which the perforations forming channels 10B are fewer in number and are not substantially aligned with aligned channels 10 and 10A.

In the embodiment illustrated in FIG. 9, rather than having the wear or load bearing layers as the outer layers, the semipermeable film layers constitute outer layers 50 and 52 with a permeable load bearing layer 54 laminated therebetween. This structure is formed by applying a respective adhesive coatings 56 and 58 to one side of film layers 50 and 52 and perforating the combined film and adhesive layers to provide channels 10 therethrough. Permeable load bearing layer 54 is then laminated between film layers 50 and 52 by way of adhesive layers 56 and 58. Although in this embodiment a single load bearing layer and two film layers have been described, it is to be understood that there may be just a single film layer and/or additional film layers and/or load bearing layers within the laminated structure. Although in this embodiment the perforations have been illustrated as being in alignment in film layers 50 and 52 and of being of the same diameter, the perforations, as in the previous embodiments, can have a different distribution and/or be of different diameters in each layer.

When a perforated film layer is used as an outer layer, the provision of channels of a relatively large diameter create a membrane that is not easily plugged in use.

Although perforations have been used to adjust the permeability of the membrane down to the required level, the materials used to construct the layers of the laminated structure can be selected such that their permeability characteristics, or combinations thereof, reduce the permeability of the structure to the required level. For example, the type, density, thickness, or weave pattern, such as increasing the length of the floats of the material used for the permeable load bearing wear layers, can be varied to adjust the permeability. A wear layer may be a woven or a non-woven layer. Due to the pressure applied during lamination, the perforations may be filled as the adhesive layer spreads out. The higher the laminating nip pressure, the smaller the holes. Also, the thicker the adhesive layer, the more the perforations are filled in. Therefore, by regulating the laminating conditions such as heat, pressure, dwell time and adhesive thickness, the permeability can be easily controlled. It is evident that the permeability of the membrane is adjusted by using a combination of perforations, materials and laminating conditions.

Although the membrane has been laminated by initially providing an adhesive to at least one side of a film layer and then perforating the coated structure, it is to be understood that the adhesive can also be applied to the wear layer. Furthermore, the adhesive may be in the form of a permeable bonding film or permeable web and therefore would not require perforation prior to lamination. Also, a single or multiple layer of film or web may be used for the lamination. Furthermore, the adhesive layers, or at least one of such adhesive layers or webs, may be pre-perforated prior to application between the layers to be laminated. Alternatively, the layers can be adhered through solvent lamination, where, for example, salt, contained in an adhesive slurry, can be leached out after application, to produce the pores/perforations therein.

Although a semipermeable, polymeric film layer has been described, other sheet like layers can be used for example cast structures, such as the composite lattices disclosed in British Patents GB 2,202,873 and GB 2,235,705.

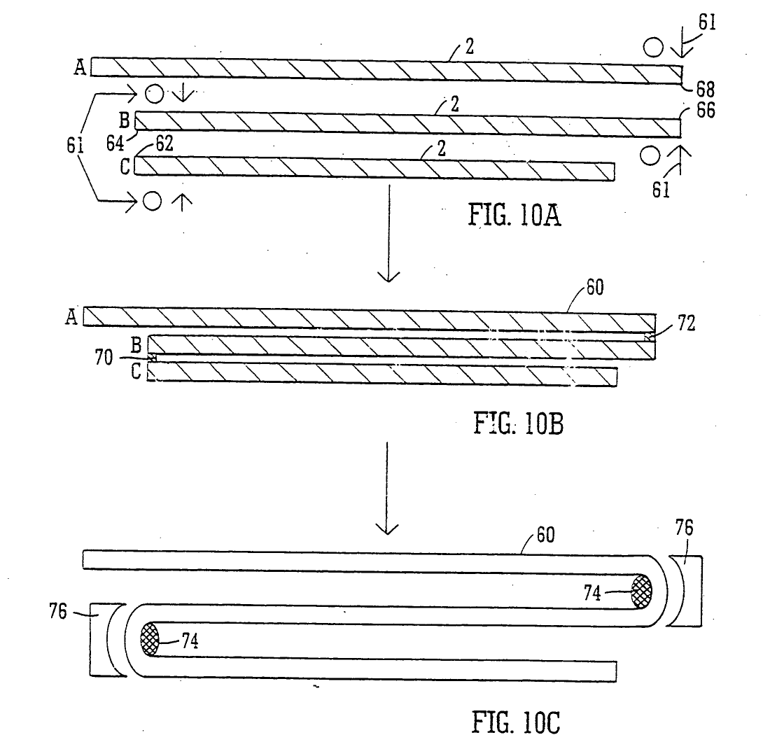

In a further embodiment, as best illustrated in FIGS. 10a to 10c, a plurality of strips A, B and C of membrane 2 are spliced together to make a wider membrane 60. To this end, as best illustrated in FIG. 10a, each strip A, B and C is threaded through a series of heated cutters 61, which act to compress adjacent strip edges 62, 64; and 66, 68 together, and fuse them, whilst also cutting off excess material that extends beyond the edge of cutter 61. Cutters 61 may alternatively be in the form of ultrasonic welders. This produces a wider material, which has a width that is substantially the sum of the widths of the strips A, B and C, which have been bonded together. Spliced material 60 is arranged in a folded accordion manner, as best illustrated in FIG. 10b, which is easy to handle. At this point in the process spliced material 60 may be used, or it can be further processed, as best illustrated in FIG. 10c, to further improve the smoothness, by flattening seam areas 70 and 72 with heat and/or ultrasonic energy directed at seam areas 70 and 72. To this end elements 74 and 76 can be heated or ultrasonic activated shoes, or rollers, or similar, which are forced together to reduce beads 70 and 72 that forms during the bonding stage. It is to be understood that the layers may be spliced either before or after lamination. Furthermore, the layers can be laminated with a stair step pattern along their edge, which is then overlapped with an inverted similarly formed membrane and laminated to make the membrane wider. Several such strips of membrane may be joined in this fashion.

It has been found that splicing narrow membranes together to make a wider membrane in this fashion produces a membrane in which the permeability of the membrane in the region of the splice is not significantly affected. Furthermore, by the selection of a variety of different widths of strips A, B and C, a spliced membrane of the required width can be formed, which requires little or no trimming, thereby leading to best use of materials with little waste. It is to be understood that although membrane strips A, B and C, as shown are each of a different width, the widths of each strip can be equal. Furthermore, the wider, spliced membrane can be constructed from any number of such strips.

Although splicing has been described to join narrow membranes together to form a wider membrane, splicing can also be used to join membranes to make the fabric longer and/or endless.

Although the application of the membrane has been described with specific reference to the displacement press described in U.S. Pat. No. 6,190,506 (Beck), and as illustrated in FIG. 3, the membrane is also particularly well adapted for use in other air presses for dewatering wet webs, for example the arrangements described in International Publications WO 99/23301 (Kimberly Clark), WO 99/23296 (Beloit) or U.S. Pat. No. 6,454,905(Kimberly-Clark).

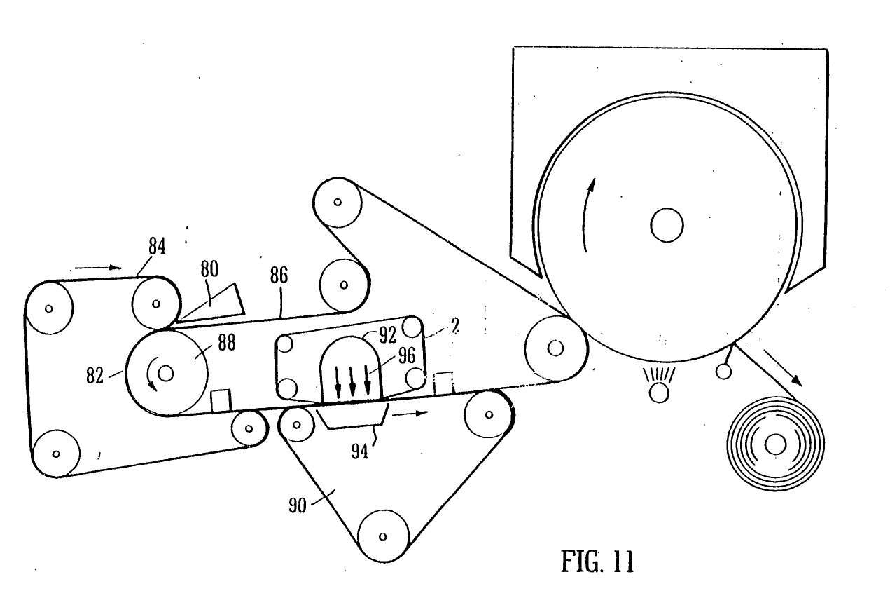

FIG. 11 is a schematic view of a modified air press which employs a permeable membrane in order to more effectively dewater a paper web/sheet. This effectively converts the air press into a displacement press.

The standard parts of the air press include a head box 80 which deposits a wet web 82 between an endless loop of a first forming fabric 84 and an endless loop of a second forming fabric 86. Partial dewatering of web 82 occurs due to the tension of forming fabric 86 and the centrifugal force as it passes around forming roll 88. Forming fabrics 84 and 86 separate and the partially dewatered web 10 is retained on second forming fabric 86, whereafter it is retained between second forming fabric 86 and an endless support fabric 90 as it passes between a pressurized plenum 92 and vacuum box 94 on respective opposite sides of the thus enclosed web 82. Pressurized plenum 92 and vacuum box 94 pass air 96 through enclosed web 82 to increase dewatering, without any substantial compressive force.

The modification to the standard air press includes the provision of an endless permeable membrane 2, which is wider than second forming fabric 86 and is adapted to completely cover the web enclosed between second forming fabric 86 and support fabric 94 as it passes between plenum 92 and vacuum box 94. Placement of permeable membrane 2, with a much lower permeability than the somewhat open structure of a forming fabric, between forming fabric 86 and plenum 92, effectively creates a barrier to the passage of some of air 96 from plenum 92 through web 82. This residual air instead acts as a source of pressure and presses membrane 2, causing the web/sheet therebelow to be squeezed. This results in an increased dewatering due to a consequential reduction in the sheet/webs void volume, causing the web to be saturated and thereby freeing water, which is then driven out by the smaller amount of air passing therethrough. Laminated permeable membrane 2, as in previous embodiments, also provides the aforementioned diffusion layer, thus additionally providing an even dewatering and efficient control of airflow.

In a further embodiment of the present invention, support fabric 90 of the air press is replaced by a permeable membrane. This has the advantage that in addition to providing the necessary support, the permeable membrane also acts as an anti-rewet layer. It is to be understood that such a permeable membrane may also be provided as an additional layer to support fabric 90.

Although permeable membrane 2 has been described as being wider than forming fabric 86, it is to be understood that such may be merely wider than the plenum, such that all of the down forcing air is directed onto the membrane.

Although conversion of the air press has been described as using a permeable membrane in the form of a laminated structure including at least one permeable wear layer and at least one semipermeable sheet layer, the membrane may be a different membrane structure having a low permeability, which may include a single layer or multiple layers. The permeability is ideally less than 50 cfm, as measured by TAPPI test method TIP 0404-20, and as above creates a barrier to the passage of some of air 96 from plenum 92. The blocked air acts on the membrane, which in turn exerts a compressive force on the web/sheet to be dewatered.

Such a membrane, of low-permeability, may also be used to replace, or alternatively be used in conjunction with, support fabric 90 to act as an anti re-wet layer.

The preceding specific embodiments are illustrative of the practice of the invention. It is to be understood, however, that other expedients known to those skilled in the art or disclosed herein may be employed without departing from the spirit of the invention or scope of the appended claims.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A permeable membrane, for use in one of a displacement press and for converting an air press into a displacement press, the permeable membrane comprising a laminate structure having a plurality of layers including at least one permeable wear layer and at least one semi-permeable perforated sheet layer.

2. The permeable membrane of claim 1, wherein at least one of said wear layers is a woven layer.

3. The permeable membrane of claim 1, wherein at least one of said plurality of layers is made of a non-woven textile selected from a list that includes spun-bonded and hydro-entangled.

4. The permeable membrane of claim 1, wherein said at least one permeable wear layer is selected such that it carries a predetermined load and prevents said sheet layer from reaching its yield point.

5. The permeable membrane of claim 1, wherein the membrane has a natural plane, the membrane having properties that are symmetrical on either side of said natural plane.

6. The permeable membrane of claim 1, wherein said sheet layer includes a plurality of pores.

7. The permeable membrane of claim 1, wherein said at least one permeable wear layer is two wear layers forming outer wear layers with said at least one semi-permeable perforated sheet layer disposed therebetween.

8. The permeable membrane of claim 1, wherein said at least one sheet layer is at least two sheet layers, at least one said permeable wear layer being laminated between adjacent sheets of said at least two sheet layers.

9. The permeable membrane of claim 1, wherein said at least one sheet layer is at least two sheet layers having pores therein.

10. The permeable membrane of claim 9, wherein said pores are at least one of smaller and fewer in said sheet layer nearest to an intended high pressure side of the membrane as compared to those of said sheet layer nearer an intended sheet side of the membrane.

11. The permeable membrane of claim 1, wherein at least one of said wear layer and said sheet layer is made of materials of at least one of polyesters, polyamides, polyurethane (PU), polyphenylene sulphide (PPS), polyetherether ketone (PEEK), polypropylene, polyethylene, and temperature resistant materials.

12. The permeable membrane of claim 1, wherein at least one of said wear layer and said sheet layer includes an outer layer that is at least one of abrasion resistant, resistant to soil pick-up and able to control static generation.

13. The permeable membrane of claim 1, wherein the membrane includes channels through the membrane arranged in a pre-selected manner.

14. The permeable membrane of claim 1, further comprising at least one adhesive layer that is at least one of permeable and perforated.

15. The permeable membrane of claim 1, wherein said wear layer is located at the intended web facing side of the membrane.

16. The permeable membrane of claim 1, wherein the permeability of the membrane is less than 50 cfm, as measured by TAPPI test method TIP 0404-20.

17. The permeable membrane of claim 16, wherein said permeability is less than 10 cfm.

18. The permeable membrane of claim 17, wherein said permeability is less than 5 cfm.

19. The permeable membrane of claim 1, wherein said at least one wear layer and said at least one sheet layer combine to form at least three layers with a low permeable, high flow resistant layer on the intended high pressure side of the membrane.

20. The permeable membrane of claim 1, further comprising an impermeable coating applied adjacent an edge of the membrane.

21. The permeable membrane of claim 20, wherein said edge of the membrane is tapered.

22. The permeable membrane of claim 1, wherein the membrane is a composite structure composed of a plurality of strips of said laminate structure being spliced together to make the membrane at least one of wider, longer and endless.

23. The permeable membrane of claim 22, wherein at least one of said strips has a stair-step pattern due to an offset arrangement of edges of individual layers within said strip, said strip being spliced to an adjacent strip having a substantially inverted image of said stair-step pattern.

24. The permeable membrane of claim 22, wherein at least one of said layers is a composite structure including a plurality of strips which are spliced together to make said layer at least one of wider, longer and endless.

25. The permeable membrane of claim 24, in which at least two of said layers are composite structures, each composed of a plurality of strips which have been spliced together to make each said composite structure at least one of wider, longer and endless, said composite structures being laminated together such that said splices are substantially offset.

26. The permeable membrane of claim 25, wherein said strips have at least one of a plurality of widths and a plurality of lengths.

27. A method of making a permeable membrane for use in at least one of a displacement press and to convert an air press into a displacement press, comprising the steps of:
providing a permeable wear layer and a semi-permeable sheet layer;
coating at least one side of said sheet layer with adhesive, thereby forming an adhesive coated sheet layer;
perforating said adhesive coated sheet layer to provide pores through said sheet layer and said adhesive, thereby forming a perforated sheet layer; and
laminating said perforated sheet layer to said permeable wear layer.

28. The method of claim 27, further comprising the step of providing a second permeable wear layer, said step of coating includes the step of coating both sides of said sheet layer with said adhesive, said laminating step including the step of laminating said coated sheet layer between said two permeable wear layers, said wear layers forming outer layers of the membrane.

29. The method of claim 28, further comprising the step of providing a second perforated adhesive coated sheet layer and a third permeable wear layer, said laminating step further comprising laminating said two perforated adhesive coated sheet layers between one of said outer wear layers with a load bearing permeable wear layer between said perforated adhesive coated sheet layers.

30. The method of claim 27, wherein said perforating step results in a reinforcing ring around each of said pores.

31. The method of claim 27, further comprising the steps of:
splicing two permeable membranes together to make a wider membrane by laying one edge of a first membrane over an edge of a second membrane; and
fusing said edges together to form a seam.

32. The method of claim 31, further comprising the step of trimming excess material.

33. The method of claim 31, further comprising the step of smoothing said seam.

34. The method of claim 27, further comprising the step of controlling the permeability, by adjusting at least one laminating condition including at least one of the heat of said lamination step, the pressure dwell time of said lamination step and the thickness of said adhesive layer.

35. The method of claim 27, further comprising the step of controlling the permeability, by using at least one of adjusting said laminating conditions, selecting the number of said perforations, selecting the distribution of said perforations and selection of materials used to construct said layers.

36. A displacement press for pressing a fiber web, comprising:
an endless fabric; and
an other endless fabric being a permeable membrane having a laminate structure with a plurality of layers including at least one permeable wear layer and at least one semi-permeable perforated sheet layer, said permeable membrane being wider than said endless fabric such that said permeable membrane covers said endless fabric and the fiber web carried thereon.

37. The displacement press of claim 36, wherein said endless fabric is also a permeable membrane including a laminate structure having at least one permeable wear layer and at least one semi-permeable sheet layer.

38. The displacement press of claim 37, wherein said endless fabric comprises at least two sheet layers, one of said two sheet layers being less permeable than the other and lies nearer an intended web supporting side of said fabric.

39. An air press which has been converted into an air displacement press using a permeable membrane, comprising:
one of a laminate structure and a low permeable membrane, said laminate structure having a plurality of layers including at least one permeable wear layer and at least one semi-permeable perforated sheet layer, said low permeability membrane having a permeability of less than 50 cfm, as measured by TAPPI test method TIP 0404-20.

40. The air press of claim 39, further comprising:
an endless forming fabric; and
an endless support fabric which along with said endless forming fabric carries a web to be dewatered therebetween;
a pressurized plenum located above said forming fabric; and
a vacuum box located below said support fabric, the permeable membrane being located between said plenum and said forming fabric.

41. The air press of claim 40, wherein said membrane is wider than at least one of said forming fabric and said plenum.

42. The air press of claim 40, wherein said support fabric is one of a permeable membrane and a low permeability membrane.

43. The air press as claimed in claim 42, wherein said support fabric includes at least two sheet layers, one of said sheet layers being less permeable than the other and lies nearer the intended web supporting side of said support fabric.

44. The air press of claim 39, wherein said permeability is less than 10 cfm.

45. The air press of claim 44, wherein said permeability is less than 5 cfm.
